(19) United States
(12) Patent Application Publication
(10) Pub. No.: US 2023/0096148 A1
(43) Pub. Date: Mar. 30, 2023

(54) MITER SAW WITH A TILT POWER-OFF MODULE

(71) Applicant: REXON INDUSTRIAL CORP., LTD., Taichung (TW)

(72) Inventors: Yu-Chuan LUNG, Taichung (TW); Xin-Hao HUANG, Taichung (TW); Ting-Yi LIAO, Taichung (TW)

(73) Assignee: REXON INDUSTRIAL CORP., LTD., Taichung (TW)

(21) Appl. No.: 17/951,418

(22) Filed: Sep. 23, 2022

(30) Foreign Application Priority Data
Sep. 30, 2021 (TW) 110136514

(51) Int. Cl. B27G 19/02; B23D 45/04; B23D 59/00

(52) U.S. Cl. CPC B27G 19/02; B23D 45/044; B23D 59/001

(57) ABSTRACT

A miter saw includes a worktable and a cutting unit. The cutting unit includes a movable arm pivotably connected with the worktable, a saw blade, a triggering switch and a tilt power-off module. The movable arm defines a reference plane which intersects a working surface of the worktable at an included angle. The tilt power-off module is disposed to detect the included angle and shift the triggering switch between a power-on state and a power-off state. The triggering switch is shifted to the power-off state when the tilt power-off module detects that the included angle is less than a predetermined breaking angle so as to prevent rotation of the saw blade in a folded position for safety purposes.

### CROSS-REFERENCE TO RELATED APPLICATION

This application claims priority of Taiwanese Patent Application No. 110136514, filed on Sep. 30, 2021.

### FIELD

The disclosure relates to a miter saw, and more particularly to a miter saw with a tilt power-off module.

### BACKGROUND

A conventional miter saw includes a worktable, a movable arm disposed on the worktable, and a saw blade disposed on the movable arm. The movable arm is rotatable relative to the worktable about a moving axis, and has a base axle portion, a cantilever portion, a handle and a triggering switch. The base axle portion extends along the moving axis, and has an end pivotably connected with the worktable. The cantilever portion is pivotably connected with the other end of the base axle portion, and extends in a direction that is transverse to the moving axis. The saw blade is disposed on a distal end of the cantilever portion away from the base axle portion. The handle is disposed on the cantilever portion. The triggering switch is disposed on the handle and is operated to trigger rotation of the saw blade. In use, a workpiece is placed on the worktable. A cutting angle of the saw blade is adjusted by turning and positioning the base axle portion relative to the worktable. Then, an operator grips the handle, pushes the triggering switch to rotate the saw blade, and pulls the cantilever portion toward the worktable to cut the workpiece. After the cutting is completed, the cantilever portion is moved away from the worktable to remove the saw blade from the workpiece. The triggering switch is then released to stop rotation of the saw blade.

Also, the movable arm may be turned about the moving axis to a folded position where the movable arm is close to or approximately flush with the worktable when the miter saw is not in use for facilitating storage of the same. However, when it is desired to carry the folded miter saw, the operator may grip the handle and accidentally operate the triggering switch by mistake, which will cause rotation of the saw blade and endanger the operator.

### SUMMARY

Therefore, an object of the disclosure is to provide a miter saw that can alleviate at least one of the drawbacks of the prior art.

According to the disclosure, the miter saw includes a base seat unit and a cutting unit. The base seat unit includes a worktable. The worktable has a working surface. The cutting unit includes a movable arm which is pivotably connected with the worktable, a saw blade which is disposed on the movable arm, a triggering switch which is disposed on the movable arm to be operated to drive rotation of the saw blade, and a tilt power-off module which is disposed on the movable arm. The movable arm is operated to rotate relative to the worktable about a moving axis which extends in an axial direction parallel to the working surface. The movable arm defines a reference plane which intersects the working surface at an included angle. The movable arm is moved relative to the worktable between a working position and a folded position. The tilt power-off module is disposed to detect the included angle and shift the triggering switch between a power-on state and a power-off state such that the tilt power-off module shifts the triggering switch to the power-off state when the tilt power-off module detects that the included angle is less than a predetermined breaking angle.

With the tilt power-off module detecting the included angle and bringing the triggering switch to the power-off state when the movable arm is moved close to the folded position, the risk of accidental operation of the triggering switch is minimized so as to prevent undesired rotation of the saw blade.

### BRIEF DESCRIPTION OF THE DRAWINGS

Other features and advantages of the disclosure will become apparent in the following detailed description of the embodiment with reference to the accompanying drawings, of which:

FIG. 1 is a perspective view illustrating an embodiment of a miter saw according to the disclosure;

FIG. 2 is a top view illustrating the embodiment;

FIG. 3 is a top view similar to FIG. 2, illustrating a worktable turned to another position;

FIG. 4 is a schematic side view illustrating a movable arm in a working position;

FIG. 5 is a schematic side view similar to FIG. 4, illustrating the movable arm being moved toward a folded position;

FIG. 6 is a schematic side view similar to FIG. 4, illustrating the movable arm in the folded position;

FIG. 7 is a perspective view illustrating the embodiment in a state when the movable arm is in the folded position;

FIG. 8 is a schematic view illustrating a state when the embodiment is carried by an operator;

FIG. 9 illustrates a flow diagram of the embodiment in use.

### DETAILED DESCRIPTION

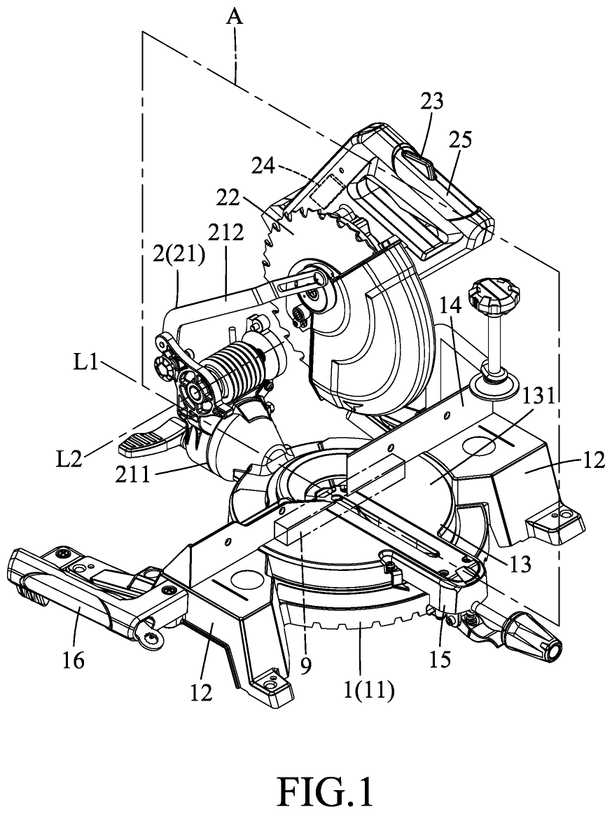

Referring to FIG. 1, an embodiment of a miter saw according to the disclosure includes a base seat unit 1 and a cutting unit 2.

The base seat unit 1 includes a base seat 11, two foot stand holders 12 respectively disposed on two opposite sides of the base seat 11, a worktable 13 turnably disposed on the base seat 11, a fence 14 disposed between the foot stand holders 12, an extension module 15 connected between the base seat 11 and the worktable 13, and a carry handle 16 connected with one of the foot stand holders 12. The extension module 15 is disposed to releasably lock the worktable 13 relative to the base seat 11.

The worktable 13 has a working surface 131 placed horizontally and facing upwardly in use such that the fence 14 is disposed above the working surface 131 of the worktable 13 to permit a workpiece 9 placed on the working surface 131 to abut against the fence 14 for stabilizing the workpiece 9 during cutting.

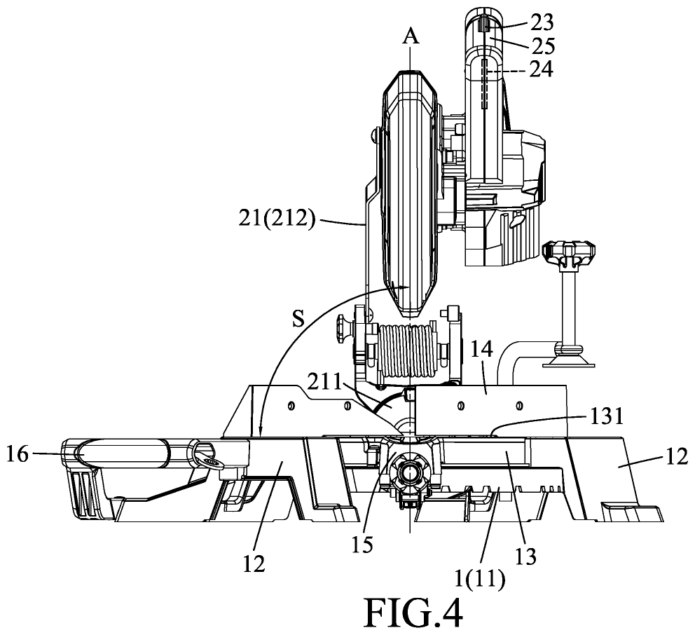

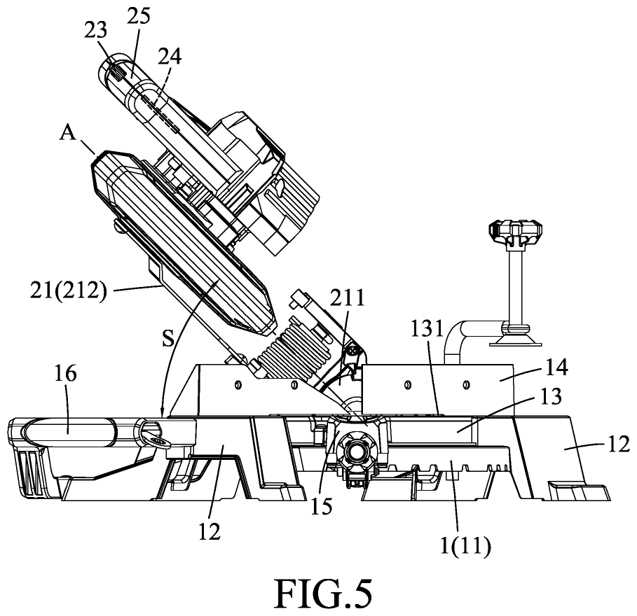

The cutting unit 2 includes a movable arm 21 which is pivotably connected with the worktable 13, a saw blade 22 which is disposed on the movable arm 21, a triggering switch 23 which is disposed on the movable arm 21 to be operated to drive rotation of the saw blade 22, a tilt power-off module 24 which is disposed on the movable arm 21, and a trigger handle 25 which is disposed on the movable arm 21. The movable arm 21 has a base axle portion 211 which extends along a moving axis that extends in an axial direction parallel to the working surface 131, and a cantilever portion 212 which is pivotably connected with the base axle portion 211 and which extends in a cantilever extending direction that is transverse to the moving axis. The base axle portion 211 is rotatable relative to the worktable 13 so as to permit the movable arm 21 to be operable to rotate about the moving axis. The cantilever portion 212 is rotatable relative to the base axle portion 211 about a bending axis. The bending axis is perpendicular to the moving axis. The saw blade 22, the tilt power-off module 24 and the trigger handle 25 are disposed on the cantilever portion 212. The triggering switch 23 is disposed on the trigger handle 25 and adjacent to the tilt power-off module 24. The cantilever portion 212 cooperates with the base axle portion 211 to define a reference plane. The reference plane intersects the working surface 131 of the worktable 13 at an included angle, as shown in FIGS. 4, 5 and 6.

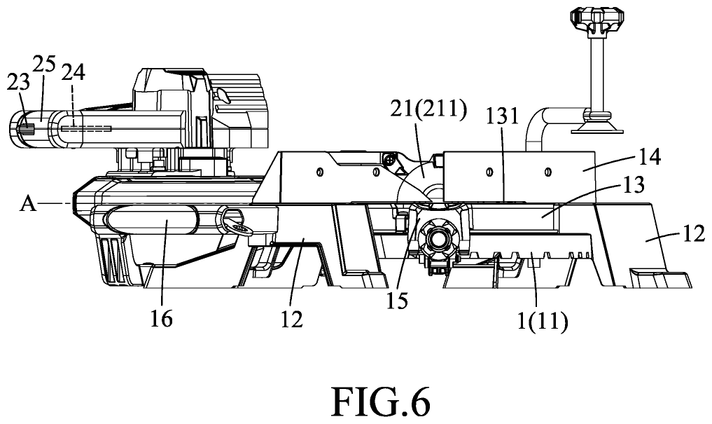

The movable arm 21 is movable relative to the worktable 13 between a working position and a folded position. In the working position, the included angle is substantially 90 degrees (as shown in FIG. 4). In the folded position, the included angle is substantially 0 degrees (as shown in FIG. 6).

It is noted that, in this context, the term “substantially” semantically encompasses both the terms “approximately” and “equal to”. In other words, the included angle may be more than or less than 90 degrees in the working position, and may be more than 0 degrees in the folded position. Additionally, as shown in FIGS. 4, 5 and 6, the reference plane of the movable arm 21 is tilted leftwardly toward the folded position. Alternatively, the movable arm 21 may be tilted and collapsed rightwardly. Specifically, as the movable arm 21 is tilted the included angle will be defined by an acute angle between the reference plane and the working surface 131.

The tilt power-off module 24 is disposed to detect the included angle and shift the triggering switch 23 between a power-on state and a power-off state. Specifically, when the tilt power-off module 24 detects that the included angle is less than a predetermined breaking angle, such as 25 degrees, the tilt power-off module 24 shifts the triggering switch 23 to the power-off state. The triggering switch 23 is disposed to be kept in this power-off state, and is shifted to the power-on state after receiving a wake-up signal from the tilt power-off module 24.

When the triggering switch 23 is in the power-on state and is triggered, the saw blade 22 is rotated. When the triggering switch 23 is in the power-on state and is not triggered, the saw blade 22 is not rotated. When the triggering switch 23 is in the power-off state, the saw blade 22 is not rotated regardless of whether the triggering switch 23 is triggered.

In this embodiment, the breaking angle is preset to be 25 degrees, but can be preset to other angles according to the operational requirements. Moreover, the tilt power-off module 24 has a gyroscope to measure and detect the included angle. The tilt power-off module 24 may have any suitable means for detecting the included angle. Furthermore, in this embodiment, the triggering switch 23 is triggered via pressing. The wake-up signal is generated by pressing and holding the triggering switch 23 for a preset duration, for example, a few seconds.

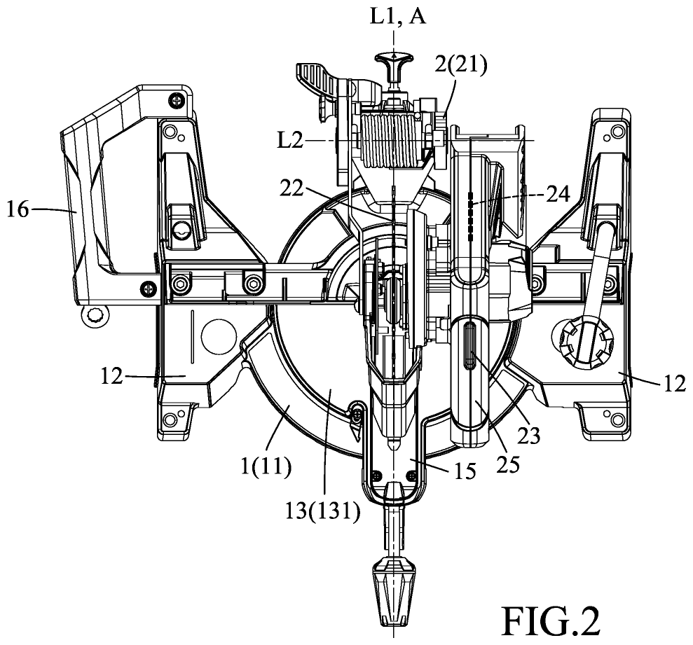

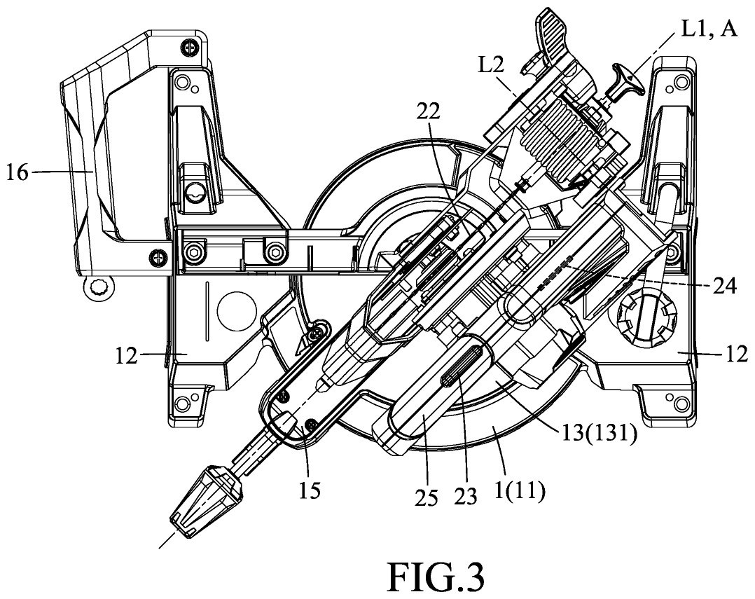

In operation, a workpiece 9 is placed on the worktable 13 and abuts against the fence 14 (as shown in FIG. 1). Subsequently, the worktable 13 is turned and adjusted to a desired cutting angle relative to the base seat 11, as shown in FIGS. 2 and 3. Through the rotation of the movable arm 21 about the moving axis, a tilted angle of the saw blade 22 relative to the working surface 131 is adjusted, as shown in FIGS. 4, 5 and 6.

After adjustment of the desired cutting angle of the saw blade 22 is completed, a cutting operation is performed. Firstly, the operator grips the trigger handle 25 and presses the triggering switch 23 to actuate rotation of the saw blade 22. The operator then forces the trigger handle 25 to rotate the cantilever portion 212 about the bending axis so as to bring the saw blade 22 toward the workpiece 9 for cutting the workpiece 9. Thereafter, the trigger handle 25 is moved to remove the saw blade 22 from the workpiece 9, and the triggering switch 23 is released to stop rotating the saw blade 22.

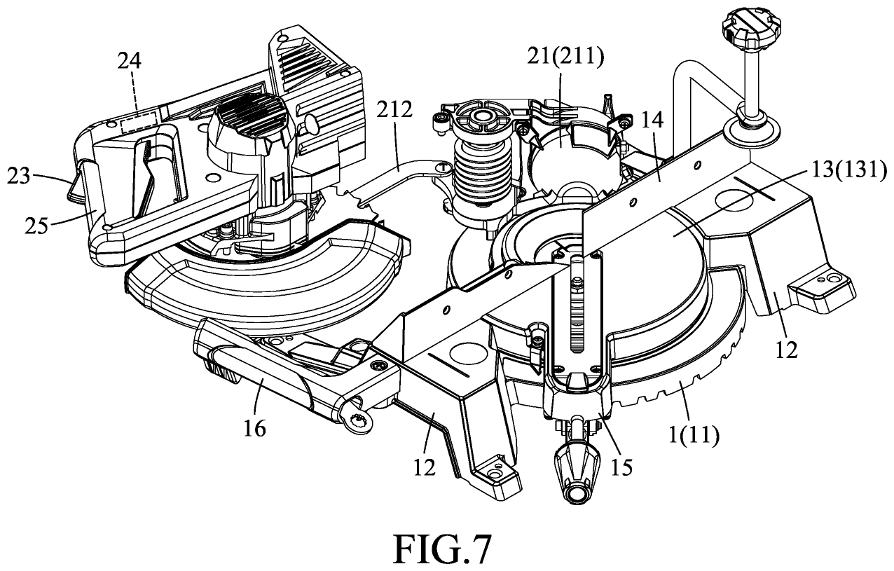

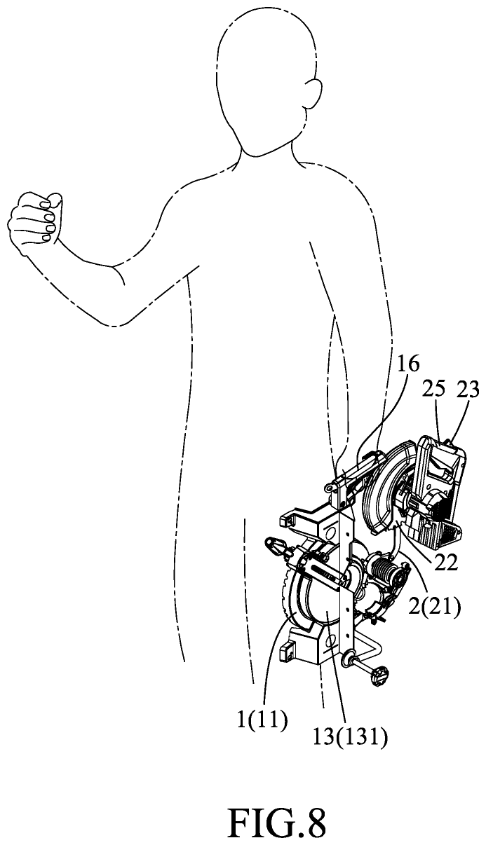

When it is desired to fold and store the miter saw, the worktable 13 and the movable arm 21 are operated by following the sequence of FIGS. 2 to 6 so as to shift the miter saw to the state shown in FIG. 7. Specifically, through turning of the worktable 13 to move the movable arm 21 away from the carry handle 16, and through rotation of the movable arm 21 about the moving axis to the folded position, the movable arm 21 and the saw blade 22 are folded to one side of the base seat unit 1 so as to reduce the storage space thereof. Then, the operator carries the carry handle 16 to transport the miter saw, as shown in FIG. 8.

Alternatively, the movable arm 21 may be folded to the other side of the base seat unit 1. Specifically, the worktable 13 is turned to move the movable arm 21 adjacent to the carry handle 16. The movable arm 21 is then rotated about the moving axis to the folded position so as to fold the movable arm 21 and the saw blade 22 to the side of the base seat unit 1.

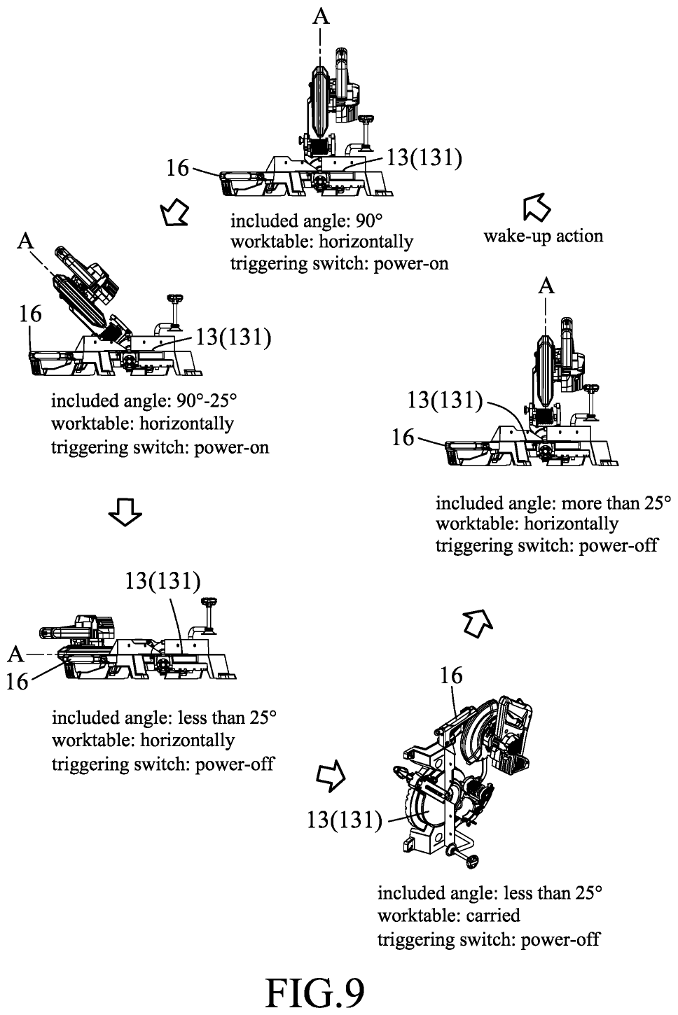

Since the triggering switch 23 is shifted to the power-off state by the tilt power-off module 24 when the included angle is less than the predetermined breaking angle, and since, when the triggering switch 23 is in the power-off state, the saw blade 22 is not rotated regardless of whether the triggering switch 23 is triggered, in the folding and storing process of the miter saw (also with reference to FIG. 9), the movable arm 21 and the saw blade 22 are folded to a side of the base seat unit 1 such that the triggering switch 23 is shifted to the power-off state and kept in the power-off state, which prevents rotation of the saw blade 22 even when accidental operation of the triggering switch 23 occurs.

In this embodiment, the tilt power-off module 24 has a gyroscope to measure and detect the included angle. The tilt power-off module 24 might determine the included angle to be 90 degrees when the miter saw is carried with the carry handle 16, as shown in FIG. 8. This is because the tilt power-off module 24 detects the tilt angle in the gravity coordinate system and indirectly determines the included angle based on the precondition that the worktable is horizontal, rather than directly detecting the included angle. For this reason, when the worktable is not placed horizontally (e.g., when the miter saw is carried), a wrong measurement of the included angle by the tilt power-off module 24 will be made. However, even in this case, where the included angle is incorrectly determined, the triggering switch 23 is still kept in the power-off state until receiving a wake-up signal. Thus, the risk of accidental operation of the triggering switch 23 is minimized. For the next use of the miter saw, the worktable 13 is placed horizontally and a wake-up action is performed.

As illustrated, with the movable arm 21 and the saw blade 22 being folded at the side of the base seat unit 1, the storage space for the miter saw is reduced.

Moreover, with the tilt power-off module 24 detecting the included angle and bringing the triggering switch 23 to the power-off state when the movable arm 21 is moved close to the folded position, the risk of accidental operation of the triggering switch 23 is minimized so as to improve the safety of the miter saw.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. A miter saw comprising:
a base seat unit including a worktable, said worktable having a working surface; and
a cutting unit including a movable arm which is pivotably connected with said worktable, a saw blade which is disposed on said movable arm, a triggering switch which is disposed on said movable arm to be operated to drive rotation of said saw blade, and a tilt power-off module which is disposed on said movable arm, said movable arm being operated to rotate relative to said worktable about a moving axis which extends in an axial direction parallel to said working surface, said movable arm defining a reference plane which intersects said working surface at an included angle, wherein
said movable arm is moved relative to said worktable between a working position and a folded position, and
said tilt power-off module is disposed to detect the included angle and shift said triggering switch between a power-on state and a power-off state such that said tilt power-off module shifts said triggering switch to the power-off state when said tilt power-off module detects that the included angle is less than a predetermined breaking angle.

2. The miter saw as claimed in claim 1, wherein said movable arm of said cutting unit has a base axle portion which extends along the moving axis, and a cantilever portion which is pivotably connected with said base axle portion and which extends in a cantilever extending direction that is transverse to the moving axis, said saw blade and said tilt power-off module being disposed on said cantilever portion, said cantilever portion cooperating with said base axle portion to define the reference plane.

3. The miter saw as claimed in claim 2, wherein said cantilever portion is pivotably connected with said base axle portion about a bending axis which is perpendicular to the moving axis.

4. The miter saw as claimed in claim 1, wherein said cutting unit further includes a trigger handle which is disposed on said movable arm, said triggering switch being disposed on said trigger handle and adjacent to said tilt power-off module.

5. The miter saw as claimed in claim 1, wherein said base seat unit further includes a base seat, two foot stand holders respectively disposed on two opposite sides of said base seat, a fence disposed between said foot stand holders, and an extension module connected between said base seat and said worktable, said worktable being turnably disposed on said base seat and having said working surface facing upwardly in use, said fence being disposed above said worktable, said extension module being disposed to lock said worktable relative to said base seat.

6. The miter saw as claimed in claim 5, wherein said base seat unit further includes a carry handle which is connected with one of said foot stand holders.

7. The miter saw as claimed in claim 1, wherein the breaking angle is 25 degrees.

8. The miter saw as claimed in claim 1, wherein said tilt power-off module has a gyroscope.

9. The miter saw as claimed in claim 1, wherein said triggering switch is disposed to be kept in the power-off state once the included angle is less than the breaking angle, and shifted to the power-on state when receiving a wake-up signal from said tilt power-off module.
